(19) United States
(12) Patent Application Publication
(10) Pub. No.: US 2011/0168381 A1
(43) Pub. Date: Jul. 14, 2011

(54) Osmotic Water Transfer System and Related Processes

(75) Inventors: John R. Herron, Corvallis, OR (US); Edward Beaudry, Corvallis, OR (US)

(73) Assignee: Hydration Systems, LLC, Scottsdale, AZ (US)

(21) Appl. No.: 12/965,874

(22) Filed: Dec. 11, 2010

Related U.S. Application Data
(60) Provisional application No. 61/285,824, filed on Dec. 11, 2009.

(51) Int. Cl. E21B 21/06; B01D 39/14; B01D 29/00

(52) U.S. Cl. 166/75.12; 210/500.21; 210/493.4; 210/323.1

(57) ABSTRACT

A forward osmosis water transfer system is disclosed which recycles water from an incoming wastewater stream into an outgoing dilute process brine stream. The system includes a saturated brine stream, a first portion of which is diverted to form a saturated process brine stream and a second portion of which is diverted to at least one forward osmosis membrane. The at least one forward osmosis membrane moves water from the incoming wastewater stream into the incoming diverted saturated brine stream thereby creating an outgoing concentrated wastewater stream and the outgoing dilute process brine stream.

### CROSS-REFERENCE TO RELATED APPLICATION

This application claims priority to the pending provisional application entitled “Osmotic Water Transfer System and Related Processes”, Ser. No. 61285824, filed Dec. 11, 2009, the entire disclosure of which is hereby incorporated herein by reference.

### BACKGROUND

1. Technical Field

This document relates to an osmotic water transfer system and related processes.

2. Background

In a variety of industrial, food-processing and energy applications, brine, or a salt-containing solution, is involved in various unit operations and process steps. At the same time, however, the process generates a wastewater which is difficult and expensive to treat.

Conventional approaches to water recovery/purification from contaminated waste streams have included boiling, filtering, ion exchange and others. These solutions generally require a significant energy input in order to separate the water from the contaminants present in solution.

### SUMMARY

Aspects of this document relate to osmotic water transfer systems and related processes that use osmotic pressure to enable transport of desired chemical components of a mixture across a membrane. These aspects may include, and implementations may include, one or more or all of the components and steps set forth in the appended CLAIMS, which are hereby incorporated by reference.

In one aspect, a forward osmosis water transfer system is disclosed which recycles water from an incoming wastewater stream into an outgoing dilute process brine stream. The system includes a saturated brine stream, a first portion of which is diverted to form a saturated process brine stream and a second portion of which is diverted to at least one forward osmosis membrane. The at least one forward osmosis membrane moves water from the incoming wastewater stream into the incoming diverted saturated brine stream thereby creating an outgoing concentrated wastewater stream and the outgoing dilute process brine stream.

Particular implementations may include one or more or all of the following.

The system may include a mixer that mixes the dilute process brine stream with crystalline salt thereby creating the saturated brine stream.

The at least one forward osmosis membrane may be a semipermeable membrane that keeps unwanted impurities in the concentrated wastewater stream and the outgoing dilute process brine stream clean.

The at least one forward osmosis membrane may be a cellulosic membrane.

The at least one forward osmosis membrane may be a spiral wound membrane.

The at least one forward osmosis membrane may operate in countercurrent flow, placing the incoming wastewater stream on one side of the membrane in contact through the membrane with the diverted saturated brine stream on an opposite side of the membrane.

The at least one forward osmosis membrane may include a plurality of forward osmosis membranes. The membranes may operate in a parallel flow configuration.

The water may move from the incoming wastewater stream into the diverted saturated brine stream due to only a concentration gradient.

In another aspect, a forward osmosis water transfer system for a drilling and fracking process of natural gas production is disclosed. The system recycles water from an incoming drilling mud stream into an outgoing clean dilute process brine stream for fracking The system may include a saturated brine stream, a first portion of which is diverted to form a saturated process brine stream and a second portion of which is diverted to at least one forward osmosis membrane. The at least one forward osmosis membrane moves water from the incoming drilling mud stream into the incoming diverted saturated brine stream thereby creating an outgoing concentrated drilling mud stream and the outgoing clean dilute process brine stream.

Particular implementations may include one or more or all of the following.

The system may include a mixer that mixes the clean dilute process brine stream with crystalline salt thereby creating the saturated brine stream.

The at least one forward osmosis membrane may be a semipermeable membrane that keeps unwanted impurities in the concentrated drilling mud stream and the outgoing dilute process brine stream clean.

The at least one forward osmosis membrane may be a cellulosic membrane.

The at least one forward osmosis membrane may be a spiral wound membrane.

The at least one forward osmosis membrane may operate in countercurrent flow, placing the incoming drilling mud stream on one side of the membrane in contact through the membrane with the diverted saturated brine stream on an opposite side of the membrane.

The at least one forward osmosis membrane may include a plurality of forward osmosis membranes. The membranes may operate in a parallel flow configuration.

The water may move from the incoming drilling mud stream into the diverted saturated brine stream due to only a concentration gradient.

In still another aspect, a forward osmosis water transfer system for a chlorine production process is disclosed. The system recycles water from an incoming wastewater stream into an outgoing clean dilute process brine stream. The system may include a saturated brine stream, a first portion of which is diverted to form a saturated process brine stream and a second portion of which is diverted to at least one forward osmosis membrane. The at least one forward osmosis membrane moves water from the incoming wastewater stream into the incoming diverted saturated brine stream thereby creating an outgoing concentrated wastewater stream and the outgoing clean dilute process brine stream.

Particular implementations may include one or more or all of the following.

The system may include a mixer that mixes the clean dilute process brine stream with crystalline salt thereby creating the saturated brine stream.

The system may include at least one mercury cell using the incoming diverted saturated process brine stream to generate at least the wastewater stream.

The at least one forward osmosis membrane may be a semipermeable membrane that keeps unwanted impurities in the concentrated wastewater stream and the outgoing dilute process brine stream clean.

The at least one forward osmosis membrane may be a cellulosic membrane.

The at least one forward osmosis membrane may be a spiral wound membrane.

The at least one forward osmosis membrane may operate in countercurrent flow, placing the incoming wastewater stream on one side of the membrane in contact through the membrane with the diverted saturated brine stream on an opposite side of the membrane.

The at least one forward osmosis membrane may include a plurality of forward osmosis membranes. The membranes may operate in a parallel flow configuration.

The water may move from the incoming wastewater stream into the diverted saturated brine stream due to only a concentration gradient.

Implementations of osmotic water transfer systems may have one or more or all of the following advantages.

Clean brine is created to be used as a process fluid.

Economically, because the osmosis process is used, no power inputs are required. Water moves from the waste to the brine due to a concentration gradient and not due to applied pressure or heat. The only power required is for transfer pumps to move the fluids into the system.

Water from waste streams may be recycled into brine streams of desired purity without requiring the expenditure of large amounts of energy.

The total costs of disposal may be reduced because the volumes of waste products for disposal are reduced.

The foregoing and other aspects, features, and advantages will be apparent to those of ordinary skill in the art from the DESCRIPTION and DRAWINGS, and from the CLAIMS.

### BRIEF DESCRIPTION OF DRAWINGS

Implementations will hereinafter be described in conjunction with the appended DRAWINGS (which are not necessarily to scale), where like designations denote like elements, and:

FIG. 1 is a schematic block diagram of an implementation of an osmotic water transfer system;

FIG. 2 is a depiction of fluid flow through an example spiral-wound forward-osmosis membrane filter element of an implementation of an osmotic water transfer system used in the drilling and fracking process of natural gas production; and

FIG. 3 a schematic block diagram of an implementation of an osmotic water transfer system used in the production of chlorine and caustic in the chlor/alkalai process.

### DESCRIPTION

This document features osmotic water transfer system and related process implementations which osmotically pull clean water from wastewater into a brine. There are many features of osmotic water transfer system and related process implementations disclosed herein, of which one, a plurality, or all features or steps may be used in any particular implementation.

In the following description, reference is made to the accompanying DRAWINGS which form a part hereof, and which show by way of illustration possible implementations. It is to be understood that other implementations may be utilized, and structural, as well as procedural, changes may be made without departing from the scope of this document. As a matter of convenience, various components will be described using exemplary materials, sizes, shapes, dimensions, and the like. However, this document is not limited to the stated examples and other configurations are possible and within the teachings of the present disclosure.

### Osmotic Water Transfer System

There are a variety of osmotic water transfer system implementations where water from waste streams may be recycled into brine streams of desired purity without requiring the expenditure of large amounts of energy.

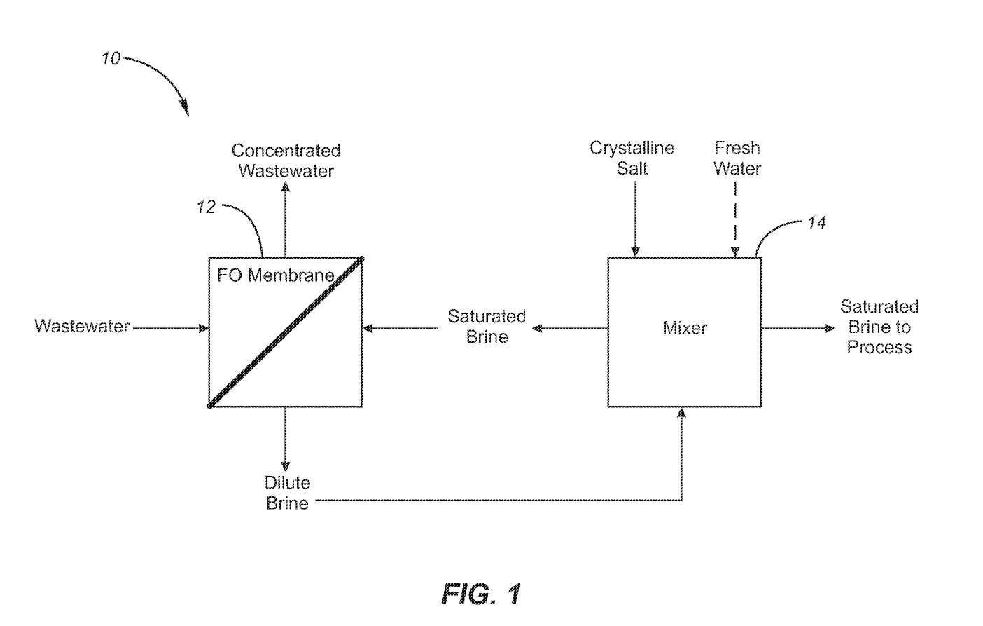

Notwithstanding, turning to FIG. 1 and for the exemplary purposes of this disclosure, osmotic water transfer system 10 and its related process is shown. Osmotic water transfer system 10 utilizes forward osmosis to move water from a wastewater stream into a saturated brine stream across a forward osmosis (FO) membrane 12, creating a concentrated wastewater stream and a dilute brine stream. The saturated brine stream is created by adding crystalline salt to the dilute brine stream in a mixer 14. A portion of the saturated brine is diverted to the process where it is needed (e.g., fracking, etc.). Optionally as depicted in a dashed line, in various implementations, a fresh water stream may be included to allow for addition of fresh water into the mixer 14.

Forward osmotic processes involve selective mass transfer across a membrane that allows a desired component to cross the membrane from a solution of higher concentration of the component to a solution of lower concentration. A semi-permeable membrane allows water to pass but blocks the movement of dissolved species. The membrane 12 may have a design similar to that disclosed in U.S. Pat. No. 4,033,878 to Foreman et al., entitled “Spiral Wound Membrane Module for Direct Osmosis Separations,” issued Jul. 5, 1977, the disclosure of which is hereby incorporated entirely herein by reference. A spiral wound membrane design configuration is inexpensive and can provide one of the greatest membrane surface areas in a vessel per cost (it can have a high membrane density (about 30 m² per 20 cm diameter by 100 cm long element)).

In general, a spiral wound configuration, a permeate spacer, a feed spacer and two membranes can be wrapped around a perforated tube and glued in place. The membranes are wound between the feed spacer and the permeate spacer. Feed fluid is forced to flow longitudinally through the module through the feed spacer, and fluid passing through the membranes flows inward in a spiral through the permeate spacer to the center tube. To prevent feed fluid from entering the permeate spacer, the two membranes are glued to each other along their edges with the permeate spacer captured between them. The feed spacer remains unglued. Module assemblies are wound up to a desired diameter and the outsides are sealed.

Specifically, the membrane forces a draw solution (i.e., brine) to flow through the entire, single membrane envelope. The brine is pumped into one end of a center tube with perforations. A barrier element fixed halfway down the tube forces the brine flow through the perforations into the membrane envelope. A glue barrier is applied to the center of the membrane envelope so that fluid must flow to the far end of the membrane where a gap allows it to cross over to the other side of the membrane envelope then back into the second half of the center tube and out of the element. While a single envelope can be employed, there may be multiple envelopes wound/wrapped around the center tube with feed fluid spacers between the envelopes.

Here in FIG. 1, because the driving force causing the transfer of mass through the membrane 12 is osmotic pressure, no additional energy input is required to cause the transfer to occur beyond what is required to place the solutions in contact with the membrane 12 (through transfer pumps, etc.). Water moves from the waste to the brine due to a concentration gradient and not due to applied pressure or heat or any other power input.

As a result, as saturated salt brine is contacted to one side of the membrane 12 and dilute wastewater is contacted to the opposite side, water will diffuse through the membrane 12 from the wastewater to the brine. The semi-permeable membrane 12 will keep unwanted impurities and sediment in the wastewater, thus, producing clean diluted brine. Depending upon the material used for the membrane 12, the structure of the membrane 12, and the arrangement of the membrane 12 within an osmotic transfer system 10, the amount and rate of transfer may be enhanced and/or controlled. The brine can then be used to dissolve more crystalline salt required for the industrial process. The volume of the wastewater is reduced, thereby reducing disposal costs.

### Other Implementations

Many additional implementations are possible.

For the exemplary purposes of this disclosure, although there are a variety of spiral wound membranes, a spiral wound FO membrane as shown and described in application Ser. No. 12/720,633, filed on Mar. 9, 2010, entitled “Center Tube Configuration for a Multiple Spiral Wound Forward Osmosis Element”, may be used, the entire disclosure of which is hereby incorporated herein by reference.

Thus, in summary, the spiral wound membrane may include an improved center tube. The perforated spiral wound membrane center tube may include at least two perforations (e.g., a plurality) through its wall (e.g., a cylindrical wall) that are in fluid communication with two internal chambers, an upstream chamber and a downstream chamber, separated from each other by a barrier element. The barrier element may be located at about the midpoint of the center tube. Sealable barrier elements are located at each open end of center tube respectively and may each comprise a sealable stab and a stab receptacle. Barrier elements all include barrier penetrations.

The perforated spiral wound membrane center tube may comprise at least one internal small diameter non-perforated tube located substantially within the outer center tube. The at least one non-perforated tube extends the length of the downstream and/or the upstream chambers out through the barrier penetrations of the barriers so that the upstream chamber of a first center tube fluidly communicates with the upstream chamber of a neighboring center tube and so on and/or the downstream chamber of a first center tube fluidly communicates with the downstream chamber of a neighboring center tube and so on.

For the exemplary purposes of this disclosure, the at least one internal non-perforated tube may comprise two tubes. In particular, a feed bypass tube may be located substantially within the center tube and extends the length of the downstream chamber out through barriers. The feed bypass tube moves osmotic agent (OA) from the upstream chamber through the barrier and out of the center tube (to the next tube to the left side, not shown) without mixing it within the downstream chamber. Similarly, the downstream exit from an upstream element (located to the right of the center tube) feeds diluted OA through an exit bypass tube (located substantially within the center tube and extending the length of the upstream chamber out through barriers) into the downstream chamber without mixing it within the upstream chamber.

Accordingly, the spiral wound element includes a perforated center tube and a spiral wound membrane envelope, and having a feed solution communicating with the membrane envelope and a draw solution communicating with the center tube. The membrane envelope may include two rectangular sheets of membrane having seals on three sides to form an inner envelope chamber that fluidly communicates with the interior of the membrane center tube through the plurality of perforations, and wherein a partial length barrier is provided within each membrane envelope to increase fluid flow paths. The upstream and downstream chambers may have a torturous interconnection path through the membrane envelope.

For the exemplary purposes of this disclosure, the spiral wound FO membranes may be combined in a system, such as a spiral wound FO membrane system as shown and described in application Ser. No. 12/720,633, filed on Mar. 9, 2010, entitled “Center Tube Configuration for a Multiple Spiral Wound Forward Osmosis Element”, the entire disclosure of which is hereby incorporated herein by reference.

Thus, in summary, spiral wound FO membrane system implementations allow the brine to flow through all membranes in a housing in parallel. In general, the membrane system may include at least one element. For example, there may be a stack of at least two elements. For another example, there me from about one to up to 100 elements (including membrane envelopes). The center tubes of the elements have barriers at the ends and at the midpoint, and each of these barriers is penetrated by two bypass pipes. One set of bypass pipes allows concentrated OA to be conveyed independently to the OA feed side of each element, while the second set of bypass pipes conveys the diluted OA out of the stack. This arrangement allows the elements to be nested together in a stack which has only a single OA and feed connection at each end, but yet provides the OA flow through each element in a parallel configuration.

Thus, a plurality of spiral wound membranes are arranged end-to-end (and then usually within a cylindrical housing). Each of the plurality of spiral wound membranes has a first, second and so on perforated center tube each having two open ends, and a plurality of spiral wound membrane envelopes, and each having a feed solution communicating with the membrane envelopes and a draw solution communicating with the center tubes. Each center tube has two chambers, an upstream chamber and a downstream chamber, separated from each other by a barrier element. The upstream and downstream chambers may have a torturous interconnection path through the membrane envelopes. The upstream chamber of the first center tube communicates with the upstream chamber of a neighboring or subsequent center tube through a non-perforated bypass tube passing the first center tube, and the downstream chamber of the first center tube communicates with the downstream chamber of a neighboring center tube through a non-perforated bypass tube passing the first center tube. The center tubes and barriers form an inlet and an outlet manifold, such that all the upstream sections of the center tubes are connected together in parallel and all of the outlet downstream sections of the center tubes are connected together in parallel. The non-perforated bypass tubes passing the center tubes may be connected to sealable stabs and stab receptacles located at the open ends of each center tube.

Further implementations are within the CLAIMS.

### Specifications, Materials, Manufacture, Assembly

It will be understood that implementations are not limited to the specific components disclosed herein, as virtually any components consistent with the intended operation of an osmotic water transfer system implementation may be utilized. Accordingly, for example, although particular components and so forth, are disclosed, such components may comprise any shape, size, style, type, model, version, class, grade, measurement, concentration, material, weight, quantity, and/or the like consistent with the intended operation of an osmotic water transfer system implementation. Implementations are not limited to uses of any specific components, provided that the components selected are consistent with the intended operation of an osmotic water transfer system implementation.

Accordingly, the components defining any osmotic water transfer system implementation may be formed of any of many different types of materials or combinations thereof that can readily be formed into shaped objects provided that the components selected are consistent with the intended operation of an osmotic water transfer system implementation. For example, the components may be formed of: rubbers (synthetic and/or natural) and/or other like materials; glasses (such as fiberglass), carbon-fiber, aramid-fiber, any combination thereof, and/or other like materials; polymers such as thermoplastics (such as ABS, Acrylic, Fluoropolymers, Polyacetal, Polyamide; Polycarbonate, Polyethylene, Polysulfone, and/or the like), thermosets (such as Epoxy, Phenolic Resin, Polyimide, Polyurethane, Silicone, and/or the like), any combination thereof, and/or other like materials; composites and/or other like materials; metals and/or other like materials; alloys and/or other like materials; any other suitable material; and/or any combination thereof.

For the exemplary purposes of this disclosure, the FO membranes used in various implementations of osmotic water transfer system implementations may be constructed of a wide variety of materials and have a wide variety of operating characteristics. For example, the membranes may be semi-permeable, meaning that they pass substantially exclusively the components that are desired from the solution of higher concentration to the solution of lower concentration, for example, passing water from a more dilute solution to a more concentrated solution. Any of a wide variety of membrane types may be utilized using the principles disclosed in this document.

Also, FO membrane may be made from a thin film composite RO membrane. Such membrane composites include, for example, a cellulose ester membrane cast by an immersion precipitation process on a porous support fabric such as woven or nonwoven nylon, polyester or polypropylene, or preferably, a cellulose ester membrane cast on a hydrophilic support such as cotton or paper. The RO membrane may be rolled using a commercial thin film composite, sea water desalination membrane. The membranes used for the FO element (in any configuration) may be hydrophilic, membranes with salt rejections in the 80% to 95% range when tested as a reverse osmosis membrane (60 psi, 500 PPM NaC1, 10% recovery, 25.degree. C.). The nominal molecular weight cut-off of the membrane may be 100 daltons. The membranes may be made from a hydrophilic membrane material, for example, cellulose acetate, cellulose proprianate, cellulose butyrate, cellulose diacetate, blends of cellulosic materials, polyurethane, polyamides. The membranes may be asymmetric (that is the membrane has a thin rejection layer on the order of 10 microns thick and a porous sublayer up to 300 microns thick) and may be formed by an immersion precipitation process. The membranes are either unbacked, or have a very open backing that does not impede water reaching the rejection layer, or are hydrophilic and easily wick water to the membrane. Thus, for mechanical strength they may be cast upon a hydrophobic porous sheet backing, wherein the porous sheet is either woven or non-woven but having at least about 30% open area. The woven backing sheet is a polyester screen having a total thickness of about 65 microns (polyester screen) and total asymmetric membrane is 165 microns in thickness. The asymmetric membrane may be cast by an immersion precipitation process by casting a cellulose material onto a polyester screen. The polyester screen may be 65 microns thick, 55% open area.

For the exemplary purposes of this disclosure, the brines may generally be inorganic salt based or sugar-based. For example, a brine may be Sodium chloride=6.21 wt %; Potassium chloride=7.92 wt %, Trisodium citrate=10.41 wt %, Glucose=58.24 wt %, and Fructose=17.22 wt %.

Various osmotic water transfer system implementations may be manufactured using conventional procedures as added to and improved upon through the procedures described here. Some components defining osmotic water transfer system implementations may be manufactured simultaneously and integrally joined with one another, while other components may be purchased pre-manufactured or manufactured separately and then assembled with the integral components.

Manufacture of these components separately or simultaneously may involve extrusion, pultrusion, vacuum forming, injection molding, blow molding, resin transfer molding, casting, forging, cold rolling, milling, drilling, reaming, turning, grinding, stamping, cutting, bending, welding, soldering, hardening, riveting, punching, plating, and/or the like. If any of the components are manufactured separately, they may then be coupled with one another in any manner, such as with adhesive, a weld, a fastener, wiring, any combination thereof, and/or the like for example, depending on, among other considerations, the particular material forming the components.

For the exemplary purposes of this disclosure, in one implementation a process for making a spiral wound membrane filter element or module may include: (a) assembling an envelope sandwich; (b) assembling a center tube onto the envelope sandwich; and (c) wrapping the envelope sandwich having the center tube and glue to form the spiral wound membrane module.

### Use

Implementations of an osmotic water transfer system are particularly useful in FO/water treatment applications. Implementations may be employed as multiple-element industrial-scale FO membrane housings because the fluid can be pumped through them in parallel. Notwithstanding, any description relating to water treatment applications is for the exemplary purposes of this disclosure, and implementations may also be used with similar results in a variety of other applications, such as industrial, food-processing and energy applications.

In describing the use of osmotic water transfer system implementations further and for the exemplary purposes of this disclosure, in the production of natural gas, drilling of the hole for a natural gas well is accomplished by injecting drilling mud through the center of a rotating auger. The drilling mud carries the rock cuttings back up the bore of the well and is subsequently stored in a pond at the drilling site. Because of the composition of the drilling mud (which includes water and salt), the drilling mud often requires disposal through a deep well injection process, requiring pumping of the mud into a truck and hauling it to the injection well. Because often over one million gallons of drilling mud are generated from the drilling of a single natural gas well, disposal of the drilling mud becomes a significant contributor to the total cost of the well.

Once natural gas bearing rock has been reached using the auger, the natural gas well is formed through a fracking process that includes the high pressure injection into the bore of clean brine with the same salinity as the existing groundwater. The clean brine must be free from particles and sediment because sediment in the frack water creates plugs in the fractures in the natural gas bearing rock that are formed by the frack process. Because the brine solution must be clean, before the present system implementations, it generally was brought to the well site, because the existing drilling mud cannot be used for the fracking process.

Since water is present in the drilling mud, osmotic water transfer system implementations can retrieve the water from the drilling mud and use it to create the clean brine solution for fracking This reduces the cost of disposal of the drilling mud, and minimizes the expense of providing the clean brine solution and the water required for the frack process.

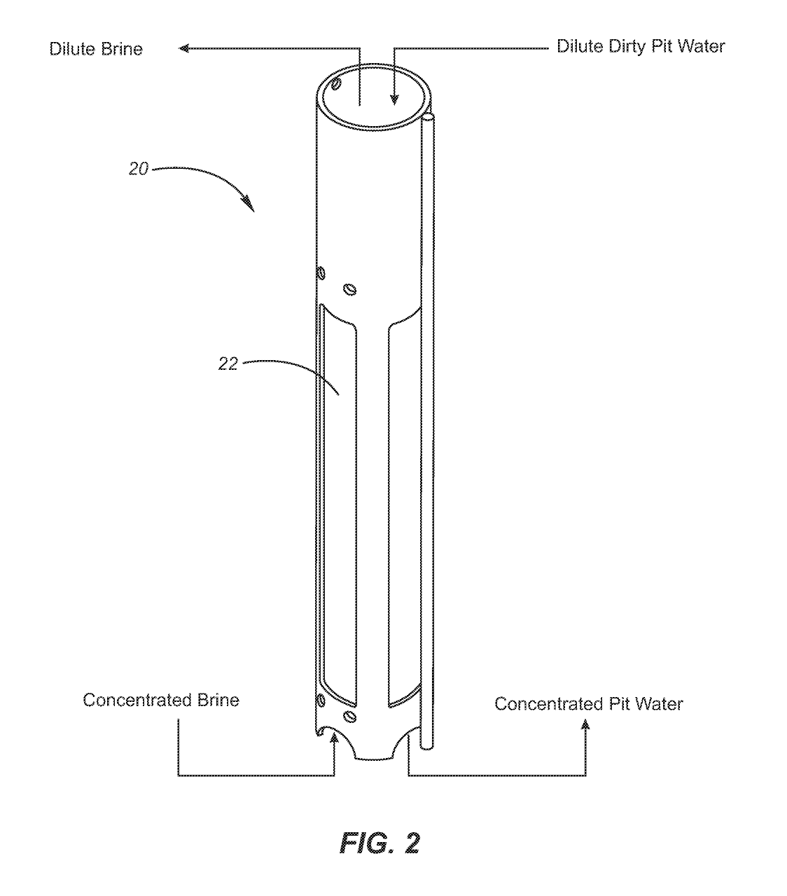

Referring to FIG. 2, fluid flow is illustrated through an example spiral-wound forward-osmosis membrane filter element 20 that can be employed in an osmotic water transfer system like system 10. As illustrated, element 20 operates in countercurrent flow, placing a stream of dilute drilling mud (dirty pit water) in contact with a concentrated brine stream through membrane 22. The exit streams from each side of element 20 are a diluted brine stream and a concentrated drilling mud stream ready for disposal. While the terms “dilute” and “concentrated” are used in various locations in this document, these are relative terms and simply indicate that a particular stream or solution contains more or less of a particular component of the mixture than the stream or solution from which it came, was derived, or has been placed in osmotic contact with.

In a particular example, devices like element 20 illustrated in FIG. 2 were tested with sodium chloride brine and “pit water” (stored drilling mud) from a natural gas drilling operation in Logansport, Louisiana. Sodium chloride brine was used in combination with forty, 8 inch diameter and 40 inch long spiral-wound forward osmosis membrane filter elements 20 manufactured by Hydration Technologies of Albany, Oregon. Forward osmosis membrane 22 was included in each element 20. In the membrane 22 design used in the test, the brine was placed on the so-called permeate side of the membrane 22 to promote forward osmosis. Each element 20 had 16 m² of effective membrane 22 area and the membrane 22 material was cellulose triacetate.

In the test, forty forward osmosis membrane 22 filters were operated in parallel flow to enable transfer of water from the dilute drilling mud to the concentrated brine stream. The volumetric flow of dilute drilling mud to each of the osmotic water transfer units was 6 l/min and the initial salt concentration of the dilute drilling mud was 4.9 g/l NaCl. The concentrated brine stream entered the osmotic water transfer units at an NaCl concentration of 25% and at 0.5 l/min. The dilute brine stream left the osmotic water transfer units at a concentration of 6% and a rate of 2.0 l/min. The dilute drilling mud was circulated through the forty osmotic transfer units until the initial volume of drilling mud of 100,000 gallons was reduced to 20,000 gallons.

As indicated in FIGS. 2, 50 to 80 percent of the water was recovered from the dilute drilling mud, while the concentrated brine was diluted to a concentration of two to eight percent (clean frack water), using an osmotic water transfer system employing elements 20 and a control valve or metering pump to control the brine feed rate and salt concentration of the resulting frack water.

In describing the use of osmotic water transfer system implementations further and for the exemplary purposes of this disclosure, in the chlor/alkali industry, a sodium chloride containing brine is used in various processes. Clean sodium chloride brine is required. In some processes, the brine is electrolytically split to form chlorine gas and a sodium hydroxide solution. The brine is created by bringing crystalline salt to the plant which is subsequently dissolved in clean water to create the brine used in the process. In other process unit operations and stages, various amounts of wastewater are created by purges, cleaning, and the regeneration of ion exchange resins used in ion exchange columns. Discharge of this wastewater is becoming progressively more regulated and expensive.

Using an osmotic water transfer system implementation, the amount of clean water needed to create the brine solution is reduced because water can be recovered from the wastewater created by the plant. This also reduces the cost of disposal of the wastewater while reducing the amount of clean water needed to be input into the brine creation process. In short, an osmotic water transfer system implementation can extract clean water for the process brine from the wastewater, greatly decreasing its volume, relieving regulatory pressure, and saving much of the disposal cost.

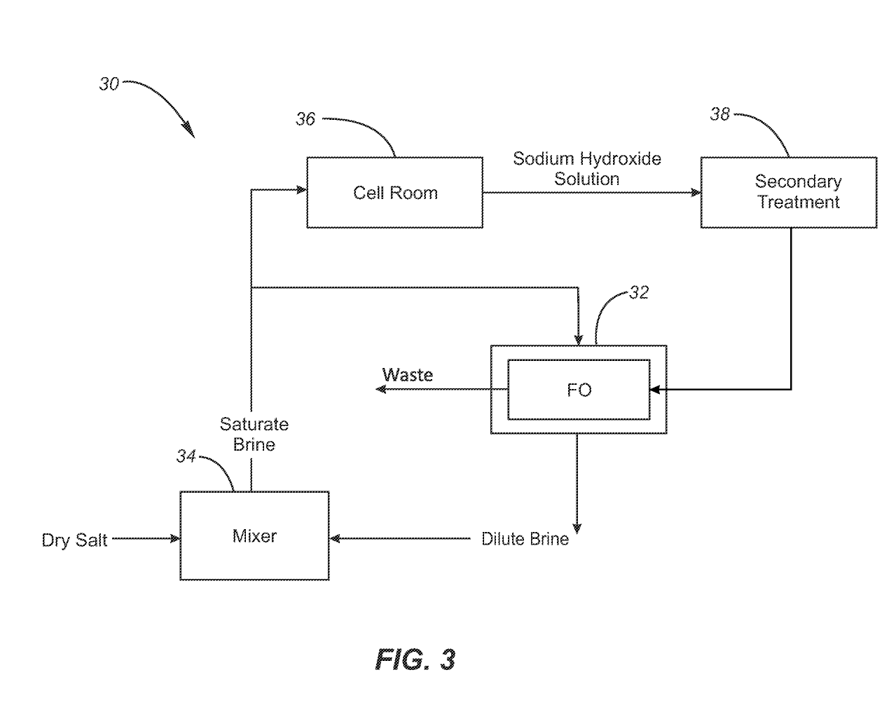

Referring to FIG. 3, an implementation of an osmotic water transfer system 30 can operate as a mercury cell chlorine production process. As illustrated, solid salt is mixed with a dilute brine solution in a mixer 34 to form saturated brine (e.g., 310 gpm) that is transferred to a cell room 36 with a plurality of mercury cells that react the sodium in the saturated brine with mercury at the cathode, generating chlorine gas, hydrogen gas, and a sodium hydroxide solution e.g., 5-10 ppm Hg and 1000-26000 ppm salt depending on brine purge). The resulting sodium hydroxide solution is transferred to a secondary treatment stage 38 (e.g., batch tank-35,000 gals—or 300 gpm, 10-20 ppb Hg, 1000-26000 ppm salt, 2.5-4 pH) where it is further processed to remove mercury. The effluent from the secondary treatment stage 38 then passes to forward osmosis membranes 32 operating in counterflow with a portion of the saturated brine stream. The forward osmosis membranes 32 receive saturated brine and transfer water from the effluent from the secondary treatment stage 38 to form a waste stream with 50% to 90% of the water removed and a dilute brine stream containing a small residual amount of mercury (e.g., <12 ppt Hg). Because of the significant reduction in volume of the waste stream resulting from the recovery of the water, the costs of disposal of the waste stream (which contains a certain amount of mercury) can be significantly reduced.

In places where the description above refers to particular implementations, it should be readily apparent that a number of modifications may be made without departing from the spirit thereof and that these implementations may be alternatively applied. The accompanying CLAIMS are intended to cover such modifications as would fall within the true spirit and scope of the disclosure set forth in this document. The presently disclosed implementations are, therefore, to be considered in all respects as illustrative and not restrictive, the scope of the disclosure being indicated by the appended CLAIMS rather than the foregoing DESCRIPTION. All changes that come within the meaning of and range of equivalency of the CLAIMS are intended to be embraced therein.

1. A forward osmosis water transfer system for recycling water from an incoming wastewater stream into an outgoing dilute process brine stream comprising:
a saturated brine stream, a first portion of which is diverted to form a saturated process brine stream and a second portion of which is diverted to at least one forward osmosis membrane; and
the at least one forward osmosis membrane that moves water from the incoming wastewater stream into the incoming diverted saturated brine stream thereby creating an outgoing concentrated wastewater stream and the outgoing dilute process brine stream.

2. The system of claim 1 further comprising a mixer that mixes the dilute process brine stream with crystalline salt thereby creating the saturated brine stream.

3. The system of claim 1 wherein the at least one forward osmosis membrane is a semipermeable membrane.

4. The system of claim 3 wherein unwanted impurities are kept in the concentrated wastewater stream and the outgoing dilute process brine stream is clean.

5. The system of claim 1 wherein the at least one forward osmosis membrane is a cellulosic membrane.

6. The system of claim 1 wherein the at least one forward osmosis membrane is a spiral wound membrane.

7. The system of claim 1 wherein the at least one forward osmosis membrane comprises a plurality of forward osmosis membranes.

8. The system of claim 7 wherein the plurality of forward osmosis membranes operate in a parallel flow configuration.

9. The system of claim 1 wherein the at least one forward osmosis membrane operates in countercurrent flow, placing the incoming wastewater stream on one side of the membrane in contact through the membrane with the diverted saturated brine stream on an opposite side of the membrane.

10. The system of claim 1 wherein the water moves from the incoming wastewater stream into the diverted saturated brine stream due to only a concentration gradient.

11. A forward osmosis water transfer system for a drilling and fracking process of natural gas production, the system recycling water from an incoming drilling mud stream into an outgoing clean dilute process brine stream for fracking, the system comprising:
a saturated brine stream, a first portion of which is diverted to form a saturated process brine stream and a second portion of which is diverted to at least one forward osmosis membrane; and
the at least one forward osmosis membrane that moves water from the incoming drilling mud stream into the incoming diverted saturated brine stream thereby creating an outgoing concentrated drilling mud stream and the outgoing clean dilute process brine stream.

12. The system of claim 1 further comprising a mixer that mixes the clean dilute process brine stream with crystalline salt thereby creating the saturated brine stream.

13. The system of claim 1 wherein the at least one forward osmosis membrane is a semipermeable spiral wound membrane.

14. The system of claim 1 wherein the at least one forward osmosis membrane comprises a plurality of forward osmosis membranes.

15. The system of claim 14 wherein the plurality of forward osmosis membranes operate in a parallel and countercurrent flow configurations, placing the incoming drilling mud stream on one side of the membranes in contact through the membranes with the diverted saturated brine stream on an opposite side of the membranes.

16. A forward osmosis water transfer system for a chlorine production process, the system recycling water from an incoming wastewater stream into an outgoing clean dilute process brine stream, the system comprising:
a saturated brine stream, a first portion of which is diverted to form a saturated process brine stream and a second portion of which is diverted to at least one forward osmosis membrane; and
the at least one forward osmosis membrane that moves water from the incoming wastewater stream into the incoming diverted saturated brine stream thereby creating an outgoing concentrated wastewater stream and the outgoing clean dilute process brine stream.

17. The system of claim 16 further comprising a mixer that mixes the clean dilute process brine stream with crystalline salt thereby creating the saturated brine stream.

18. The system of claim 16 further comprising at least one mercury cell using the incoming diverted saturated process brine stream to generate at least the wastewater stream.

19. The system of claim 16 wherein the at least one forward osmosis membrane is a semipermeable spiral wound membrane.

20. The system of claim 16 wherein the at least one forward osmosis membrane comprises a plurality of forward osmosis membranes that operate in a parallel and countercurrent flow configurations, placing the incoming wastewater stream on one side of the membranes in contact through the membranes with the diverted saturated brine stream on an opposite side of the membranes.
